(19) United States
(12) Patent Application Publication
(10) Pub. No.: US 2006/0199902 A1
(43) Pub. Date: Sep. 7, 2006

(54) Compositions made from isocyanate, method for use thereof for the production of adhesives an aromatic glue joints thus obtained

(76) Inventors: Vincent Granier, Vernaison (FR); Corinne Varron, Lyon (FR)

Correspondence Address: RHODIA INC., 259 PROSPECT PLAINS ROAD, CN 7500, CRANBURY, NJ, 08512, US

(21) Appl. No.: 10/552,520

(22) PCT Filed: Mar. 31, 2004
(86) PCT No.: PCT/FR04/00808

§ 371 Date: Oct. 7, 2005

(30) Foreign Application Priority Data
Apr. 8, 2003 (FR) 03/04343

(51) Int. Cl. C08G 18/08

(52) U.S. Cl. 524/589

(57) ABSTRACT

The invention relates to the use of an emulsifiable isocyanate composition in adhesives. The composition comprises an isocyanate composition with a mass content of the N═C═O function from 10% to 30% and a viscosity of at most 1,500 mPa·s. and a detergent agent with a main component of a compound or a mixture of compounds containing phosphorous and ethylene oxide groups and an oxygen atom carrying an anion. The above is of application in the adhesive industry.

The present invention relates to compounds and compositions based on isocyanates (which may be partially masked, but this is not the preferred embodiment). The invention is also directed toward the process for using them and their use for making adhesives, especially glue joints thus obtained. The invention more particularly relates to (self-)dispersible compositions in aqueous phase, especially for bonding wood and elastomer.

In order to understand the invention more clearly, it would appear appropriate to recall the following.

In the present description, the particle size characteristics often refer to notations of the type dₙ in which n is a number from 1 to 99; this notation is well known in many technical fields, but is rather more rare in chemistry, and it may thus be worthwhile recalling its meaning. This notation represents the particle size such that n % (by weight, or more exactly by mass, since the weight is not an amount of material but a force) of the particles is less than or equal to said size.

In the rest of the description, the polydispersity index will be used, which is defined as:
I=(d₉₀−d₁₀)/d₅₀

Solvents have been widely used in the adhesives industry for a long time, but the use of organic solvents is coming under increasing criticism by the authorities in charge of safety at work, since these solvents, or at least some of them, are notoriously toxic or chronotoxic.

This is one of the reasons for which attempts are increasingly made to develop techniques that replace the techniques in solvent medium to overcome the drawbacks associated with solvents.

To reduce the use of organic solvent, the presence of which is notoriously toxic for those handling it and harmful to the environment, it has been proposed to develop adhesives in aqueous phase.

The vast majority of adhesives of this type consist of polymer(s), usually in the form of a dispersion, in an aqueous phase whose evaporation brings about the bonding.

However, it is seen that the adherence properties of the glue joints obtained with this kind of adhesive could be significantly enhanced by the presence of isocyanate dispersed in said aqueous phase. The mechanism of this potentialization is not completely elucidated.

Thus modified, these dispersions constitute a novel class of adhesive, and are formed from a dual dispersion in the same aqueous phase of polymer(s) (soluble or, usually, in dispersion) on the one hand, and of dispersed isocyanate on the other hand.

In general, this mixed dispersion is obtained either by mixing the polymer-vector aqueous phase with an isocyanate emulsion; or by direct emulsification of the isocyanate in the aqueous phase bearing the polymer.

It is the latter technique that is the most desired.

Despite the advantage of this technique, there are few choices in the range of isocyanate-based compositions suitable for this use, since they need to satisfy a variety of constraints and the choice of emulsifiers is critical.

Thus, the technique for emulsifying the isocyanate composition needs to be compatible with the polymer vector medium in order to avoid, on the one hand, a reduction in the time during which the dispersion may be used for bonding, and, on the other hand, demixing with possible phase separation. This implies both physical stability of the dispersions and also a certain level of chemical stability.

The reason for this is that, usually, when unmasked or incompletely masked isocyanates are used, in the form of an aqueous emulsion, the time for which they can be used remains less than a few hours, in general one or two hours. It is important to ensure that the use of novel emulsifiers is not reflected by a shorter service life.

The problem is all the more difficult since the diversity of adhesive polymers used is wide and since their characteristics depend on the surface to be bonded.

Finally, it often arises that the glue joints obtained with adhesive in aqueous phase, and especially in dispersion, show reduced adherence in a humid environment.

In addition, many surfactants are well known to impair the strength of the bond between the coating and its support. As a result, they are known and used to undermine the attachment between a polymer and a support.

This is why one of the aims of the present invention is to provide an isocyanate composition that can be readily emulsified under a wide range of conditions.

Another aim of the present invention is to afford an isocyanate composition that overcomes the problems of adherence in a humid environment.

These aims, and others that will become apparent hereinbelow, are achieved by means of using in the adhesives an emulsifiable isocyanate composition comprising:
an isocyanate composition with a mass content of N═C═O function of between 10% and 30% (limits inclusive) and advantageously from 15% to 25% (limits inclusive) and with a viscosity of not more than 2500 mPa.s, advantageously not more than 1500 mPa·s, preferably not more than 1400 mPa·s and even not more than 1200 mPa·s, a surfactant comprising as main constituent a compound or mixture of compounds of general formula: 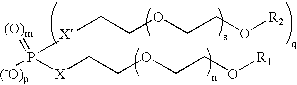
in which:
   p represents an integer between 1 and 2 (closed intervals, i.e. including the limits);
   m represents zero or 1;
   q is chosen between zero and one;
   the sum p+m+q is not more than 3;
   the sum 1+p+2 m+q is equal to 3 or 5, advantageously to 5;
   X is an oxygen or a single bond;
   X′ is an oxygen or a single bond;
   n and s, which may be identical or different, represent an integer chosen between 5 and 30, advantageously between 5 and 25 and preferably between 9 and 20 (closed intervals, i.e. including the limits), in which R₁ and R₂, which are different or, advantageously, identical, are chosen from optionally substituted aryl radicals.

Advantageously, one of the X and X′ is oxygen and preferably both are oxygen.

It is preferable that, in the case of a mixture of compounds of formula (I), the majority (at least 50%) of them on a molar basis corresponds to formula (I) with “q” being 0 (i.e. phosphoric monoester or phosphonate) to give formula (II): 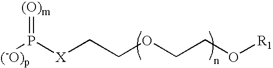
with:
“m” being equal to 0 or 1, preferably 1
“p” being 2.

When a mixture of compounds is used, the values that are integers for a defined molecule become values that may be fractional.

Thus, in formula (I), q, p and especially n and s become statistical values.

The emulsifiable composition then becomes an emulsifiable isocyanate composition comprising:
an isocyanate composition with a mass content of N═C═O function of between 15% and 25% and with a viscosity of not more than 1500 mPa·s, advantageously not more than 1400 mPa.s and preferably not more than 1200 mPa·s;
a surfactant comprising as main constituent a compound or mixture of compounds of mean general formula: 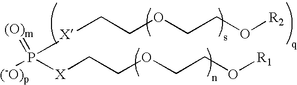
in which:
   p represents a value between 1 and 2 (closed intervals, i.e. including the limits);
   m represents 0 or 1, advantageously 1;
   the sum p+m+q is equal to 3;
   the sum 1+p+2 m+q is equal to 3 or 5, advantageously 5;
   X is an oxygen;
   X′ is an oxygen;
   n and s have the same statistical value, chosen between 5 and 30, advantageously between 5 and 25 and preferably between 9 and 20 (closed intervals, i.e. including the limits); in which R₁ and R₂, which are identical, are chosen from optionally substituted aryl radicals.

R₁ and R₂ usually represent an alkylaryl of 10 to 20 carbon atoms, especially a nonylphenyl.

It should be noted that the statistical ratio “q” which is chosen in the closed interval ranging from zero to 1 is readily determined by acid-base titration.

It is then desirable for the statistical “q” to be not more than 0.5, advantageously not more than 0.3 and preferably not more than 0.2.

In this case, the mean formula is a numerical mean (total number of each type of unit or of atom divided by the number of molecules), the proportions of each molecule being measured by liquid chromatography, where appropriate, for the heavy molecules by gel permeation, where appropriate complemented with the MALDITOF technique.

These compounds may be obtained by partial esterification of phosphorus acids, advantageously phosphoric acids, with polyethylene oxides (of s and n units) ending with an alcohol function and starting with a phenol (R₁ and R₂), advantageously phenol, advantageously substituted, preferably with a carbon-based chain, which is advantageously alkyl.

The mass ratio between, on the one hand, said compounds of formula (I) (numerator) and, on the other hand, the isocyanates to be suspended, is usually not more than about 0.1 and advantageously not more than about 0.10. In the present description, the term “about” is used solely to emphasize the fact that the given values correspond to a mathematical round-up and that when the figure(s) the furthest to the right of a number are zeros, these zeros are positional zeros rather than significant figures, unless, of course, otherwise specified.

The mass ratio between the isocyanates to be suspended and the compounds of formula (I) is advantageously greater than 1% and preferably greater than 2%. The self-emulsifying nature that constitutes an advantage in these uses appears at and above a mass ratio of about 3% in the presence of an emulsifying compound of other types and of about 5% when the compounds of formula (I) represent at least 90% by mass of all of the surfactants used as emulsifiers.

It is also desirable for the amount of said compound(s) of formula (I) to correspond to a value of between 10⁻² and 1 and advantageously between 5×10⁻² and 0.5 phosphorus atom per liter.

Thus, the mass ratio between, on the one hand, the compounds of formula (I) (numerator) and, on the other hand, the isocyanates to be suspended (denominator) is advantageously at least equal to 2% and preferably at least equal to 4%, and not more than about 15% and preferably not more than about 10%, and this mass ratio is thus advantageously between about 2% and 15% and preferably between about 4% and 10% (2 significant figures); these intervals are closed, i.e. they include the limits).

According to the present invention, said compounds may be used alone or as a mixture with one or more surfactants.

These optional surfactants may also be chosen from other ionic compounds [especially aryl and/or alkyl sulfate or phosphate (needless to say, aryl especially includes alkylaryl, and alkyl especially includes aralkyl), aryl- or alkyl-phosphonates, -phosphinates or -sulfonates, fatty acid salt and/or zwitterionic salt] and, among the nonionic compounds, those blocked at the end of the chain or otherwise. However, nonionic compounds containing alcohol functions on at least one of the chains appear to have a slightly unfavorable effect on the (self)emulsification even though they have a favorable effect on other aspects of the composition; taking this into account, it is preferable for the content of this type of compound to represent not more than ⅓, advantageously not more than ⅕ and preferably not more than 1/10 by mass of said anionic compounds according to the invention.

The counter-cation(s) that ensures the electrical neutrality of the compounds according to the invention is advantageously monovalent and is chosen from mineral cations and organic cations that are advantageously nonnucleophilic and consequently of quaternary or tertiary nature [especially “oniums” of column V, such as phosphoniums, ammoniums (including protonated amines), or even of column VI, such as sulfoniums, etc.] and mixtures thereof, usually ammoniums, generally derived from an amine, advantageously a tertiary amine. Advantageously, it is avoided for the organic cation to have a reactive hydrogen with the isocyanate function. This explains the preference for tertiary amines.

The mineral cations may be sequestered with phase-transfer agents, for instance crown ethers.

The pKa in water of the cations derived from the protonation of the neutral bases (organic [ammonium . . . ] or mineral bases) is advantageously at least equal to 7, preferably to 8 and not more than 14, preferably not more than 12 and more preferentially not more than 10.

The cations and especially the amines corresponding to the ammoniums (protonated amines in this case) advantageously do not have any surfactant properties, but it is desirable for them to have good solubility, or in any case sufficient solubility to ensure the solubility of said compounds containing a functional group and a polyoxygenated chain, in aqueous phase and at the working concentration.

The tertiary amines and the quaternary ammoniums or phosphoniums containing not more than 16, advantageously 12, advantageously not more than 10 and preferably not more than 8 carbon atoms per “onium” function (it is recalled that it is preferred for there to be only one per molecule) are preferred.

The amines may comprise other functions and especially functions corresponding to the functions of the amino acids and of the cyclic ether functions, for instance N-methylmorpholine, or otherwise. These other functions are advantageously in a form that does not react with the isocyanate functions and does not significantly impair the solubility in aqueous phase.

It is very desirable for the anionic compounds according to the present invention to be in a neutralized form such that the pH it induces during dissolution or placing in contact in water is at least equal to 3, advantageously to 4, preferably to 5 and not more than 12, advantageously not more than 11 and preferably not more than 10.

Thus, it is preferable for only the strong or medium-strength acid functions (i.e. those with a pKa of not more than 4) to be neutralized when there is more than one of them. The weak acidities, i.e. those with a pKa of at least 5, may be partially neutralized.

As has been mentioned previously in more general terms, it is preferable for the compounds in which “q” is zero to be in largely predominant amount. Thus, when the phosphorus is a phosphorus V (i.e. 2m+p+q=5) and when compounds of the mixture are esters, it is desirable to use mixtures of monoester(s) and of diester(s) in a monoester/diester molar ratio of greater than 2, advantageously greater than 3, preferably greater than 4 and more preferentially greater than 5, or even greater than 10.

The emulsifiers according to the invention, especially the above mixtures, may also comprise from 1% to about 20% (however, it is preferable for this not to exceed about 10%) by mass of phosphoric acid and/or phosphorous acid (which will advantageously be at least partially salified so as to be within the recommended pH zones) and from 0 to 5% of pyrophosphoric acid esters. Although, technically, the presence of phosphorous acid is possible, some of its derivatives are considered to be toxic and it is therefore advisable to avoid the use of this acid, especially in cases where there is a risk of forming derivatives considered to be toxic.

The composition may also comprise a catalyst, advantageously a latent catalyst (which may be released by the action of external agents, for example visible or UV radiation, or oxygen).

According to the present invention, it is possible to readily produce a stable emulsion and especially a stable oil-in-water emulsion.

Admittedly, it is possible to obtain a “water-in-oil” emulsion, but such an emulsion is not chemically stable. “Water-in-oil” emulsions promote a hazardous, since it is occasionally abrupt, decomposition of isocyanate functions. To avoid this problem, it is recommended to add the isocyanate composition according to the invention to the aqueous phase rather than the reverse.

The aqueous phases bearing the adhesive polymers often have an appreciable surfactant property. Thus, it is not uncommon for the emulsifiable isocyante composition to be self-emulsifying in the aqueous phase bearing the adhesive polymer(s), whereas it is not self-emulsifying in pure water.

Thus, when the surfactant concentration is low, it may arise that there is demixing into two dispersions (in general emulsions): one “oil-in-water” sitting on the other, which is “water-in-oil”. As has been mentioned previously and will be developed hereinbelow, the latter dispersion is often chemically unstable, with release of carbon dioxide due to hydrolysis of the isocyanate function by the water. This situation may be overcome by means of more vigorous stirring or, better still, by increasing the emulsifier content.

The content of isocyanate composition in the final dispersion ranges from 1% to about 20%, advantageously from 2% to 15% and preferably from 3% to 10% (closed intervals, i.e. including the limits).

It is desirable for the isocyanate composition according to the invention, after dispersing or emulsifying in an aqueous phase, to have a water content of not more than 95%, advantageously not more than 90% and preferably not more than 85%, and at least 25%, advantageously at least 30% and preferably at least 35%. It is thus possible to obtain emulsions that are rich in solids.

The solvent content advantageously represents not more than 20% by mass, preferably not more than 10%, more preferably not more than 5% and even less than 1% of the final dispersion (i.e. ready to use for bonding).

According to one particularly advantageous embodiment of the present invention, after dispersing or emulsifying the isocyanate composition, the sum of the constituents of the binder (i.e. the mass contents of the isocyanate(s), emulsifiers and polymer(s) [advantageously containing function(s) bearing reactive hydrogen with the isocyanate functions, especially polyols]) in water ranges from 20% and preferably from 30% to 60% and preferably to 50% relative to the total amount of the composition.

In particular, the solids content may reach values at least equal to 40%, and even equal to 50%, or even 60%, but is generally less than 80%.

To return to the problem of emulsification, during the study that led to the present invention, in particular in the case of aliphatic isocyanates (i.e. isocyanates linked to the hydrocarbon-based skeleton (i.e. containing both hydrogen and carbon) via a saturated (sp³) carbon), it has been shown that there was a risk of runaway of various reactions when certain water proportions were reached. Thus, it is recommended to avoid compositions in which the mass ratio between, on the one hand, the amount of water in the aqueous phase and, on the other hand, the sum of the isocyanate and of the surfactant according to the invention is between 10² and ½ (0.5). If greater safety is desired, ratios of between 10⁻³ and 1 will be avoided. To prevent any entry into this hazardous zone, it is recommended to prepare the emulsion by adding the emulsifiable isocyanate composition to the aqueous phase rather than the reverse.

It is preferable to use isocyanate compositions with a viscosity of not more than 1500 mPa·s, advantageously not more than 1200 mPa·s and preferably 1000 mPa·s.

In the course of the study that led to the present invention, it was shown that the size (the granulometry) of the emulsions played a major role in the quality of the final adherence. More particularly, the polydispersity of the emulsion of the isocyanate composition when said composition is alone and when it is with the adhesive polymer is important.

Thus, it is preferable that, in the case of the isocyanate alone, the particle size d₅₀ should be not more than 25 and preferably not more than 22μ, for a polydispersity index of not more than 1.5, advantageously not more than 1.3 and preferably not more than 1.1.

When the isocyanate (or more precisely the emulsifiable isocyanate composition) is dispersed in the phase of the polymer, monodispersity is more difficult to achieve, but the results of the compounds according to the invention constitute significant progress.

The isocyanates targeted by the invention especially include the compounds detailed below.

These compounds may advantageously contain the structures known in this field, for example “prepolymers” derived from the condensation of polyol (for example trimethylolpropane) in general triol (advantageously primary) and especially the most common, i.e. oligomers such as those containing isocyanurate units (also known as trimers), those containing a uretidinedione structure (also known as dimers), biuret or allophanate structures or a combination of structures of this type on a single molecule or as a mixture.

If it is desired to substantially lower the solvent content of the composition, especially when it is in emulsion form, it is preferable to use mixtures of this type that are naturally (i.e. without addition of solvent) of low viscosity.

Compounds having this property are especially the derivatives (such as isocyanurate, also known as trimers, uretidinedione structures, also known as dimers, biuret or allophanate structures or a combination of structures of this type on a single molecule or as a mixture) partially and/or totally of aliphatic isocyanates whose isocyanate functions are linked to the skeleton via ethylene fragments [for example polymethylene diisocyanates, especially hexamethylene diisocyanate and those of arylenedialkylene diisocyanates whose isocyanate function is at least two carbons remote from the aromatic nuclei, such as (OCN-[CH₂]ₜ-Φ-[CH₂]ᵤ—NCO) with t and u greater than 1].

Thus, isocyanate compositions a) which comprise at least 50% and advantageously 70% by mass of oligomers chosen from hetero- or homooligomers in which at least one of the monomers is an aliphatic monomer, and advantageously in which all of the monomers are aliphatic monomers chosen from those bearing at least two isocyanate functions and in which the skeleton, on the shortest trajectory connecting two isocyanate functions, comprises at least one polymethylene sequence of at least two methylene chain units (CH₂)π(π≧2), which is exocyclic when the monomer comprises a ring, are advantageously used.

Oligomers that are considered include compounds with a mass of not more than about 1600, i.e., for hexamethylene diisocyanate, not more than about ten diamine units that are precursors of isocyanate functions. In said polymethylene sequence of at least two methylene chain units (CH₂)π, π represents an integer from 2 to 10 and advantageously from 4 to 8. Said oligomers are advantageously chosen from hexamethylene diisocyanate homooligomers.

These compounds or mixtures advantageously have a viscosity of not more than about 2000 centipoises (or millipascal.seconds) and preferably not more than about 1500 centipoises (or millipascal.seconds).

When these values are not reached, it is then often useful to bring the mixture to these viscosity values by adding a minimum amount of suitable solvent(s). When reactive solvents are not used (see below), it is, however, preferable for the amount of solvent in the isocyanate composition not to exceed 20% and advantageously 10% by mass of the emulsifiable isocyanate composition.

When this is compatible with the application, the solvents that are the most suitable are those that may conveniently be referred to as reactive solvents (since they have these two characteristics).

Reactive solvents that may be mentioned include aliphatic di- and triisocyante, or even tetra-isocyanate, monomers with a molecular mass of at least 200 (2 significant figures) and advantageously at least 250, and with a viscosity of not more than 500 mPa·s. Among the solvents of this type that may be mentioned are those derived from esters of diamino acids, such as lysine and ornithine, and especially LDI (lysine diisocyanate, derived from lysine ester), LTI (lysine tri-isocyanate, derived from the ester of lysine with ethanolamine) and trisubstituted alkanes such as NTI (nonyl triisocyanate OCN—(CH₂)₄—CH(CH₂—NCO)—(CH₂)₃—NCO) and UTI (undecyl triisocyanate OCN—(CH₂)₅—CH(—NCO)—(CH₂)₅—NCO). Although not developed on an industrial scale, tetraisocyanates derived from a double ester of diols [such as glycols, propanediols (especially 1,3-propanediol), butanediols (especially 1,4-butanediol) and pentanediols (especially 1,5-pentanediol)] and of diamino acids, give good results.

As reactive solvents, mention may be made of polymethylene diisocyanate dimers optionally substituted on a methylene with an ethyl or a methyl (containing a uretidinedione ring), bis-dimers (trimers containing two uretidinedione rings) and their mixtures with each other and, where appropriate, with the tris-dimers (tetramers containing 3 uretidinedione rings). Such mixtures may be made by heating the monomers (see the international patent application published under No. WO 99/07765).

As reactive solvents, mention may also be made of monoallophanates of polymethylene diisocyanate optionally substituted on a methylene with an ethyl or a methyl (dicondensate with a monoalcohol), the two kinds of bis-allophanates (tetracondensate with a diol or, preferably, tricondensate with two monoalcohols containing two allophanate functions), and mixtures of two or three of the specified species. For the synthesis of this type of product, reference may be made to the international patent application published under No. WO 99/55756.

Needless to say, mixtures of the various types of reactive solvent above may be used.

In other words, the viscosity of the isocyanate composition can be adjusted before mixing with the emulsifier to a value of not more than about 2500 centipoises (or mPa·s, i.e. milliPascal.seconds), advantageously not more than 2000 mPa·s, preferably not more than about 1500 centipoises (or milliPascal.seconds), more preferentially 1200 and even more preferentially 1000 mPa·s, by adding at least one of the above compounds; i.e. by cutting with an isocyanate composition with a viscosity of not more than 1200 mPa·s and less than the desired viscosity (i.e., respectively, 3000, 2000, 1500 and 1000 mPa·s), advantageously chosen from:
those comprising at least 10% by mass of at least one aliphatic di- and polyisocyanate monomer with a molecular mass of greater than 200 and advantageously greater than 250, and a viscosity of not more than 500 mPa·s;
those comprising at least 10% by mass of at least one derivative containing a uretidinedione ring chosen from polymethylene diisocyanate dimers and bis-dimers optionally substituted on a methylene with an ethyl or a methyl, with a viscosity of not more than 500 mPa·s;
those comprising at least 10% by mass of at least one allophanate chosen from polymethylene diisocyanate monoallophanates optionally substituted on a methylene with an ethyl or a methyl, and with a viscosity of not more than 500 mPa·s;
those formed by the mixture of the above three types of composition, with a viscosity of not more than 500 mPa.s.

As already mentioned above, the isocyanates concerned may be mono-, di- or even polyisocyanates. Advantageously, these derivatives may contain structures of isocyanurate type, also known as trimers, uretidinedione structures, also known as dimers, biuret or allophanate structures or a combination of structures of this type on a single molecule or as a mixture. It should be pointed out that the trifunctional monomers such as LTI (lysine triisocyanate) and NTI (nonyl triisocyanate) are used predominantly in unmodified form, but may be oligomerized.

The isocyanate monomers are generally derived from diamines converted into diiocyanates by carbonation; this operation is performed in the vast majority of cases by the action of phosgene or equivalent reagents; the diamine units are found, quite obviously, in the compounds derived from oligocondensation (for example dimers, trimers, allophanates, urethanes, ureas and biurets, etc.). These monomers may especially be:
[symbol] aliphatic, including cycloaliphatic and aryl-aliphatic, such as:
   simple aliphatic, polymethylene diisocyanate monomers containing polymethylene sequences (CH₂)_{π} in which ππ represents an integer from 2 to 10 and advantageously from 4 to 8, and especially hexamethylene diisocyanate, one of the methylenes possibly being substituted with a methyl or ethyl radical, as is the case for MPDI (methyl pentamethylene diisocyanate);
   partially “neopentyl” aliphatic partially cyclic (cycloaliphatic), isophorone diisocyanate (IPDI);
   cyclic aliphatic (cycloaliphatic) diisocyanate, those derived from norbornane;
   arylene dialkylene diisocyanates (such as OCN—CH₂-Φ-CH₂—NCO, a portion of which does not show any essential difference from aliphatics, i.e. those in which the isocyanate function is at least 2 carbons remote from the aromatic nuclei, such as (OCN-[CH₂]ₜ-Φ-[CH₂]ᵤ—NCO) with t and u greater than 1;
[symbol] or alternatively aromatics such as tolylene diisocyanate (however, aromatic isocyanates function poorly as regards aqueous emulsification).

The term “aliphatic isocyanate function” means an isocyanate function borne by a carbon of sp³ hybridization.

The preferred polyisocyanates targeted by the technique of the invention are those in which at least one, advantageously two and preferably three of the conditions below are satisfied:
At least one, advantageously at least two and more preferably all of the NCO functions are linked to a hydrocarbon-based skeleton via a saturated (sp³) carbon, preferably with at least one and more preferentially at least two of the subconditions below:
   at least one and advantageously two of said saturated (sp³) carbons bears at least one and advantageously two hydrogen(s) (in other words, it has been found that better results were obtained when the carbon bearing the isocyanate function bore a hydrogen and preferably two hydrogens);
   at least one and advantageously two of said saturated (sp³) carbons themselves borne by a carbon, which is advantageously aliphatic (i.e. of sp³ hybridization), itself bearing at least one and advantageously two hydrogen(s);

in other words, it has been found that better results were obtained when the carbon bearing the isocyanate function was not in a “neopentyl” position.
All the carbons via which the isocyanate functions are linked to the hydrocarbon-based skeleton are saturated (sp³) carbons, which advantageously partially and preferably totally bear a hydrogen and preferably two hydrogens; in addition, it is advantageous for said saturated (sp³) carbons to be at least partially (advantageously ⅓ and preferably ⅔), and preferably totally borne themselves by a carbon, which is advantageously aliphatic (i.e. of sp³ hybridization), itself bearing at least one and advantageously two hydrogen(s); in other words, it has been found that better results were obtained when the carbon bearing the isocyanate function was not in a “neopentyl” position.
Those at least partially having an isocyanuric or biuret skeleton (whether this skeleton is derived from only one or from several monomers, see below) and more specifically structures of isocyanurate type, also known as trimer, uretidinedione structures, also known as dimer, biuret or allophanate structures or a combination of structures of this type on a single molecule or as a mixture, are particularly suitable.

When the polyisocyanates are relatively heavy, i.e. when they comprise at least 4 isocyanate functions, the first two conditions become:
at least ⅓ and advantageously ⅔ of the NCO functions are linked to a hydrocarbon-based skeleton via a saturated (sp³) carbon;
at least ⅓ and advantageously ⅔ of said saturated (sp³) carbons bears at least one and advantageously two hydrogen(s); in other words, it has been found that better results were obtained when the carbon bearing the isocyanate function bore a hydrogen and preferably two hydrogens. In addition, it is advantageous for said saturated (sp³) carbons to be at least partially (advantageously ⅓ and preferably ⅔) and preferably totally borne themselves by a carbon, which is advantageously aliphatic (i.e. of sp³ hybridization), which itself bears at least one and advantageously two hydrogen(s); in other words, it has been found that better results were obtained when the carbon bearing the isocyanate function was not in a “neopentyl” position.

The isocyanates, especially aliphatic isocyanates, may react with some of the anionic compounds targeted by the invention to form anhydrides; these anhydrides are capable of regenerating the compounds of formula (I) and in certain cases react like masked isocyanates; the reactions for forming these anhydrides, which may moreover be inhibited by total neutralization of the acid functions with a strong base, are of two types:
either elimination of a molecule of water between two anionic functional groups and to thus form a function of the type E-O-E (i.e. a pyrophosphoric sequence in the case of phosphates);
or addition of the hydroxyl of non-neutralized or poorly neutralized acid functions, to the NCO function to form a function having the sequence —NH—CO—O-E. These compounds (mixed anhydrides between a carbamic acid and the anionic functional group) are also targeted by the present invention.

The first case corresponds to the case in which the first acidity has been imperfectly neutralized. These products also have excellent surfactant properties.

In the course of the research that led to the present invention, it was possible to show that the presence of molecules (corresponding to the concept of reactive solvent) of low molecular weight [i.e. not more than 700 (2 significant figures), advantageously 600 (2 significant figures) and preferably 500 (2 significant figures)], containing neither a hexacyclic structure, nor a biuret or even a urethane structure, could be correlated with good adherence. Such molecules are molecules containing not more than three diamine units and are essentially chosen from dimers, bis-dimers, polymethylene diisocyanate monoallophanates and trifunctional monomers of the type LTI and NTI.

Thus, advantageously, at least one of these molecules is present in the isocyanate composition a). In total, these low molecular weight molecules represent a portion ranging from 5% to 25% and advantageously from 7% to 15% by mass of the isocyanate composition a). The dimers and bis-dimers are preferred and represent by mass advantageously from 5% to 20% and preferably at least 7% of the composition a). The amount of solvent in the isocyanate composition advantageously represents not more than 20% by mass of the isocyanate composition a), preferably not more than 10% and more preferably not more than 1%.

It is preferable, for reasons of work law, for the amount of volatile monomer of the hexamethylene diisocyanate type to be not more than 1% by mass, advantageously not more than 0.5%, preferably not more than 0.2% and more preferentially not more than 0.1% by mass of the isocyanate composition a).

The nonlimiting examples that follow illustrate the invention.

Emulsifiable Composition According to the Present Invention

The emulsifiable isocyanate composition according to the present invention was prepared by adding a surfactant (or emulsifier) of statistical formula (I) to an isocyanate composition prepared from trimerized hexamethylene diisocyanate with a viscosity of less than 1200 mPa·s and comprising, by mass:

8% (±1%) of true dimer;

2% (±1%) of bis-dimer;

2% (±1%) of biuret;

55% (±2%) of true trimer.

The emulsifier used is of statistical formula (I) in which
q represents 0.3;
s and r represent 9.5;
p=1.7;
R₁ and R₂ are nonylphenyl radicals.

The amine used for the neutralization is N,N-dimethyl-hexylamine.

Phosphoric acid represents 15 mol % of the phosphorus present (in other words, the phosphorus of the phosphoric acid represents 15% of the total amount of phosphorus present).

Only the first acidity of the phosphorus acids present was neutralized.

After addition, the emulsifiable isocyanate composition comprises 7.5% (±1%) by mass of true dimer (i.e. only one uretidinedione unit and two diamine units) and 3.5% by mass of compound of formula (I). It has a viscosity of 1400 mPa·s (NCO=21.7%)

The Compound Desmodur® DN

This is a commercial composition comprising a high content (at least 70%) of true trimer (i.e. an isocyanurate ring and three diamine units) and which also comprises a neutral surfactant derived from the condensation between isocyanate oligomers and a diol that is a copolymer of ethylene oxide (46%) and propylene oxide (54%). The viscosity is 1250 mPa·s (NCO=21.8%).

The HDT-Based Composition (Product of Trimerization of Hexamethylene Diisocyanate

The HDT tested is the common product derived from trimerization with less than 2% of dimer, at a viscosity of 2400 mPa·s, to which is added 11% of the product of formula (I) specified above.

This composition is self-emulsifying.

Final viscosity: 4300 mPa·s

NCO=19%

Percentage of surfactant after addition=10%

Spatula Test

The spatula test is a qualitative test in which the test compound is taken up from the container using the flat part of a spatula and is stirred in water for 2 minutes. If there is still product visible at the end of the spatula, the test is negative. This common test is a good indicator of the ease of use.

All the tests are performed with an isocyanate composition content of 4% by mass.

The particle size measurements are performed using a Horiba LA 910 machine.

### EXAMPLE 1

### Bonding of Wood—Comparative Study of a Composition According to the Present Invention with Usual Isocyanate Compositions

Polymer vinNac DPN15 is a vinyl acetate homopolymer dispersion containing 52% solids.

The tests are performed according to standard EN205/94-D4; the breaking tests are performed on samples maintained at room temperature for 7 days according to standard E204.

The results are collated in the following table:

| | | Isocyanate alone | | | | | | |
|---|---|---|---|---|---|---|---|---|
| | | | “I”: poly- | | | | | |
| | | | dispersity | VinNac | | | | Breaking strength in |
| Isocyanate | Spatula | | index = d₁₀ − d₉₀/ | DPN15 | | Mixture | | MPa on beech |
| Tested | test | median d₅₀ | d₅₀ | d₅₀ | “I” | d₅₀ (μm) | “I” | (Fagus silvestris) |
| Product | + | 22 μm | 0.926 | 1.16 μm | 12.4 | 1.047 | 0.728 | 14 |
| according | | | | | | | | |
| to the | | | | | | | | |
| invention | | | | | | | | |
| Desmodur ® DN | + | 19 μm | 1.6 | | | 1.158 | 0.984 | 11 MPa |
| HDT trimer | − | 0.09 μm | 0.845 | | | 1.128 | 17.2 | 14 |
| (comparative) | | | | | | | | |

### EXAMPLE 2

### Bonding of Elastomer (Sports Shoes)—Comparative Study of a Composition According to the Present Invention with Usual Isocyanate Compositions

The polymer used is Dispercoll® U54 (see technical notice dated Monday Jan. 31, 2000). It is a polyurethane dispersion containing 50% polymer solids.

The tests are performed according to DIN standard EN 1392, the samples are dried for 4 days at room temperature (23° C.) and the breaking strengths are measured according to standard DIN 205/91.

| | | Isocyanate | | Dispercoll U54 | | Mixture | |
|---|---|---|---|---|---|---|---|
| Test | Spatula | median | (d₁₀ − d₉₀)/ | | d₁₀ − d₉₀/ | | d₁₀ − d₉₀/ |
| product | test | d₅₀ | d₅₀ | d₅₀ | d₅₀ | D₅₀ | d₅₀₅ |
| Invention | + | 22μ | 0.926 | 166 nm | 0.48 | 2.8μ | 16 |
| Desmodur DN | + | 19μ | 1.6 | | | Bipopulous 215 nm + | 92 |
| | | | | | | 22μ (19%) | |
| HDT | − | 0.09μ | 0.845 | | | | 0.55 |

| | Peeling: on CPU dry | Peeling: on NBR dry | Peeling on | Peeling on |
|---|---|---|---|---|
| Test product | DIN EM1392 | medium | C-PU wet | NBR wet |
| Invention | 1 | 0.69 | 0.95 | 0.67 |
| Desmodur ® DN | 1.02 | 0.67 | 0.64 | 0.47 |
| HDT | 1.1 | 0.73 | 0.67 | 0.5 |
| Disperscoll ® U 54 alone | 0.58 | 0.19 | | |

1. The use for preparing an emulsion for adhesive of a composition comprising for successive or simultaneous addition an isocyanate composition a) with a mass content of N═C═O function of between 10% and 30% (limits inclusive) and advantageously from 15% to 25% (limits inclusive) and with a viscosity of not more than 2500 mPa·s, advantageously not more than 1500 mPa·s, preferably not more than 1400 mPa·s and more preferably not more than 1200 mPa·s
a surfactant b) comprising as main constituent (i.e. at least 50% by mass) a compound or a mixture of compounds of mean general formula: 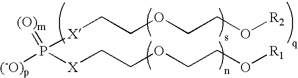
wherein:
p represents a value between 1 and 2 (closed intervals, i.e. comprising the limits);
m represents zero or 1;
the sum p+m+q is equal to 3;
the sum 1+p+2 m+q is equal to 3 or 5, advantageously 5;
X is an oxygen;
X′ is an oxygen;
n and s have the same statistical value, chosen between 5 and 30, advantageously between 5 and 25 and preferably between 9 and 20 (closed intervals, i.e. including the limits); in which R₁ and R₂, which are identical, are chosen from optionally substituted aryl radicals,
R₁ and R₂ usually represent an alkylaryl of 10 to 20 carbon atoms.

2. The use as claimed in claim 1, characterized in that the viscosity is not more than 2000, advantageously not more than 1500 mPa·s, preferably not more than 1400 mPa·s and more preferentially not more than 1200 mPa·s

3. The use as claimed in either of claims 1 and 2, characterized in that the ratio between the mass of the agent b) (numerator) and the mass of composition a) (denominator) is within the closed interval (i.e. including the limits) ranging from 2% to 10% and advantageously from 3% to 7%.

4. The use as claimed in one of claims 1 to 3, characterized in that the sum p+q is equal to 2.

5. The use as claimed in claims 1 to 4, characterized in that said isocyanate composition a) comprises at least 50% and advantageously 70% by mass of oligomers chosen from hetero- and homooligomers in which at least one of the monomers is an aliphatic monomer, advantageously in which all of the monomers are aliphatic monomers chosen from those bearing at least two isocyanate functions and in which the skeleton, on the shortest trajectory connecting two isocyanate functions, comprises at least one polymethylene sequence of at least two methylene chain units (CH₂)_{π} (π≧2), which is exocyclic when the monomer comprises a ring.

6. The use as claimed in one of claims 1 to 5, characterized in that said isocyanate composition a) comprises a portion of reactive solvent comprising at least one molecule chosen from dimers, bis-dimers, polymethylene diisocyanate monoallophanates and di-, tri- or even tetra-functional monomers with a molecular mass at least equal to 200.

7. The use as claimed in claim 6, characterized in that said portion represents a portion ranging from 5% to 20% by mass of the isocyanate composition a).

8. The use as claimed in either of claims 6 and 7, characterized in that the dimers and bis-dimers represent by mass advantageously from 5% to 20% and preferably at least 7% of the composition a).

9. An adhesive composition, characterized in that said composition also comprises, in successive or simultaneous addition:
an isocyanate composition a) with a mass content of N═C═O function of between 10% and 30% (limits inclusive) and advantageously from 15% to 25% (limits inclusive) and with a viscosity of not more than 2500 mPa·s, advantageously not more than 1500 mPa·s, preferably not more than 1400 mPa·s and even not more than 1200 mPa·s,
a surfactant b) comprising as main constituent (i.e. at least 50% by mass) a compound or mixture of compounds of general formula:
in which:
p represents an integer between 1 and 2 (closed intervals, i.e. including the limits);
m represents 0 or 1;
the sum p+m+q is equal to 3;
the sum 1+p+2 m+q is equal to 3 or 5, advantageously to 5;
X is an oxygen;
X′ is an oxygen;
n and s, which may be identical or different, represent an integer chosen between 5 and 30, advantageously between 5 and 25 and preferably between 9 and 20 (closed intervals, i.e. including the limits), in which R₁ and R₂, which are identical, are chosen from optionally substituted aryl radicals,
R₁ and R₂ usually represent an alkylaryl of 10 to 20 carbon atoms,
an aqueous phase with a pH of between 4 and 9, advantageously bearing an adhesive polymer that is known per se.

1-9. (canceled)

10. A process for the preparation of an adhesive composition comprising the step of successive or simultaneous addition to said composition of:
an isocyanate composition a) with a mass content of N═C═O function of between 10% and 30%, optionally from 15% to 25%, and with a viscosity of not more than 2500 mPa·s, and
a surfactant b) comprising a compound or a mixture of compounds of mean general formula: 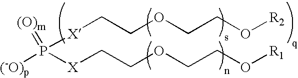
wherein:
p represents a value between 1 and 2 (closed intervals, i.e. comprising the limits);
m represents zero or 1;
the sum p+m+q is equal to 3;
the sum 1+p+2 m+q is equal to 3 or 5, optionally 5;
X is an oxygen;
X′ is an oxygen;
n and s have the same statistical value, chosen between 5 and 30, advantageously between 5 and 25 and optionally between 9 and 20 wherein R₁ and R₂, which are identical, are chosen from optionally substituted aryl radicals, and R₁ and R₂ represent an alkylaryl of 10 to 20 carbon atoms.

11. The process as claimed in claim 10, wherein the viscosity is not more than 2000, optionally not more than 1200 mPa·s

12. The process as claimed in claim 10, wherein the mass of the agent b) (numerator) and the mass of composition a) (denominator) have a ratio ranging from 2% to 10% and optionally, from 3% to 7%.

13. The process as claimed in claim 10, wherein the sum p+q is equal to 2.

14. The process as claimed in claim 10, wherein said isocyanate composition a) comprises at least 50%, optionally 70%, by mass of oligomers chosen from hetero- and homooligomers in which at least one of the monomers is an aliphatic monomer bearing at least two isocyanate functions and in which the skeleton, on the shortest trajectory connecting two isocyanate functions, comprises at least one polymethylene sequence of at least two methylene chain units (CH₂)_{π}(π≧2), which is exocyclic when the monomer comprises a ring.

15. The process as claimed in claim 10, wherein said isocyanate composition a) further comprises a portion of reactive solvent comprising at least one molecule chosen from dimers, bis-dimers, polymethylene diisocyanate monoallophanates and di-, tri- or tetra-functional monomers with a molecular mass at least equal to 200.

16. The process as claimed in claim 15, wherein said portion represents a portion ranging from 5% to 20% by mass of the isocyanate composition a).

17. The process as claimed in claim 14, wherein the dimers and bis-dimers represent by mass from 5% to 20% and optionally at least 7% of the composition a).

18. An adhesive composition, comprising:
an isocyanate composition a) with a mass content of N═C═O function of between 10% and 30% and with a viscosity of not more than 2500 mPa·s;
a surfactant b) comprising 50% by mass of a compound or mixture of compounds of general formula:
wherein:
p represents an integer between 1 and 2;
m represents 0 or 1;
the sum p+m+q is equal to 3;
the sum 1+p+2 m+q is equal to 3 or 5, optionally to 5;
X is an oxygen;
X′ is an oxygen;
n and s, which are identical or different, represent an integer chosen between 5 and 30, optionally between 9 and 20, wherein R₁ and R₂, which are identical, are chosen from optionally substituted aryl radicals,
R₁ and R₂ represent an alkylaryl of 10 to 20 carbon atoms; and
an aqueous phase with a pH of between 4 and 9.
